(19) United States
(12) Patent Application Publication
(10) Pub. No.: US 2024/0191699 A1
(43) Pub. Date: Jun. 13, 2024

(54) NACELLE OF A WIND POWER INSTALLATION AND INSTALLATION METHOD

(71) Applicant: Wobben Properties GmbH, Aurich (DE)

(72) Inventors: Frank Gerdes, Grossefehn (DE); Hannes van der Sluis, Zuthpen (NL); Jens Fellensiek, Rastede (DE)

(21) Appl. No.: 18/533,000

(22) Filed: Dec. 7, 2023

(30) Foreign Application Priority Data
Dec. 9, 2022 (EP) 22212585.8

(51) Int. Cl. F03D 80/80; F03D 13/40

(52) U.S. Cl. CPC F03D 80/85; F03D 13/40; F05B 2230/61; F05B 2240/85

(57) ABSTRACT

A nacelle that forms part of a wind power installation and is configured to be installed on a tower of the wind power installation, has an installation transformer that is configured to transform electrical power generated by the wind power installation for feeding into a medium-voltage grid, and has an electrical interface for connecting at least one medium-voltage line, wherein the line runs through the tower of the wind power installation into the nacelle, and also has a pulling device that is installed in the nacelle and comprises a pulling means, which is configured to pull the line into the nacelle for connection to the electrical interface, and has a supporting structure that is installed in the nacelle, has a receiving region for the pulling means or the line and is configured to keep the line within a predetermined bending radius in the receiving region. The supporting structure has a number of rollers that are mounted on the supporting structure so as to be able to move back and forth between an advanced, first position and a retracted, second position, wherein, in the first position, the number of rollers extend further into the receiving region than in the second position.

### BACKGROUND

### Technical Field

Embodiments of the present invention relates to a nacelle of a wind power installation, the nacelle being configured to be installed on a tower of the wind power installation, wherein the nacelle has an installation transformer that is configured to transform electrical power generated by the wind power installation for feeding into a medium-voltage grid, and has an electrical interface for connecting at least one medium-voltage line, wherein the line runs through the tower of the wind power installation into the nacelle, has a pulling device that is installed in the nacelle and comprises a pulling means configured to pull the line into the nacelle for connection to the electrical interface, and has a supporting structure that is installed in the nacelle, has a receiving region for the pulling means or the line and is configured to keep the line within a predetermined bending radius in the receiving region.

### Description of the Related Art

Wind power installations of the type outlined above are generally known. There are various installation designs on the market, including both wind power installations with a gearbox and gearless wind power installations, in which the rotational movement of the rotor blades of the wind power installation is directly converted into a movement of a rotor of a generator that generates electrical power. In the context of increasing competition in the field of wind power installations, and in view of increasing challenges in light of national legislation, wind power installation manufacturers are seeking to lower the production costs for electricity generated using the wind power installations, which also involves inter alia a reduction in the costs of manufacturing the wind power installation.

Wind power installations are often operated in arrangements, referred to as farms, in which a plurality of wind power installations feed the electrical power they generate into a medium-voltage grid, i.e. a wind-farm grid, for example, from which the power is then further distributed into the power grid or supply grid.

The applicant has proposed a wind power installation design in which, in order to lower the electricity production costs, the installation transformer, which transforms the power generated by the wind power installation into a medium voltage, i.e. a voltage for the medium-voltage grid or wind-farm grid, is relocated from the base of the wind power installation into the nacelle of the wind power installation. This significantly reduces the outlay for installing low-voltage lines between the generator of the wind power installation and the installation transformer. Therefore, instead of a multiplicity of low-voltage lines, only a single line, specifically the medium-voltage line, needs to be routed from the installation transformer through the tower of the wind power installation.

Installing the medium-voltage line is challenging in practice because, compared to low-voltage lines, the intrinsic weight of the medium-voltage line is significantly greater, specifically usually in a range of 9 kg/m or greater, and the medium-voltage line cannot be subjected to such pronounced bending stress as low-voltage lines. The medium-voltage line is therefore kept within a predetermined bending radius in the supporting structure.

### BRIEF SUMMARY

Some embodiments improve a nacelle of the aforementioned type in such a way that the electricity production costs can be reduced during the construction of the wind power installation without the performance of the wind power installation being compromised.

Some embodiments propose that the supporting structure of the nacelle has a number of rollers that are mounted on the supporting structure so as to be able to move back and forth between an advanced, first position and a retracted, second position, wherein, in the first position, the number of rollers extend further into the receiving region than in the second position.

As used herein, “a number of rollers” covers both one roller and a plurality of rollers.

Where reference is made herein to a medium-voltage grid or a medium voltage, this should be understood to mean a voltage in a low to medium two-digit kV range, for example in a range from 10 kV to 50 kV. The upper and lower limits vary slightly depending on national definitions, and so the designation “medium voltage” is directed rather more functionally to that hierarchical level of the voltage grid that occupies a mid level between the voltage of the generated electrical power on the one hand (low-voltage level) and the voltage level of the supply grid on the other hand (high-voltage level).

Some embodiments are based on the insight that, in the prior art, a significant amount of time had to be spent, during the installation of the medium-voltage line in the nacelle of the wind power installation, using a dedicated operating means, known as a cable-deflecting means or cable corner roller, to pull the medium-voltage line into the nacelle and to bend said medium-voltage line from the vertical orientation in the tower to a horizontal orientation in the nacelle to allow it to be connected to the electrical interface of the installation transformer. Since the operating means used in the prior art, for reasons relating to cost and space, was neither suitable nor designed for remaining in the installation, it was therefore the case up until now that the medium-voltage line, after being pulled into the nacelle, always had to be transferred from the operating means into the receiving region of the supporting structure, which entailed the expenditure of a considerable amount of effort and time, given the considerable weight of the medium-voltage line at the height of the nacelle, that is to say at the upper end of a tower sometimes having a height of 150 m or more.

Some embodiments include using the permanently installed supporting structure of the nacelle itself for the installation of the medium-voltage line. The movement of the number of rollers into the first position brings the supporting structure into a state in which the medium-voltage line can be pulled through the receiving region of the supporting structure, over the rollers, with a small amount of effort. The further the number of rollers are advanced into the receiving region, the more pronounced the effect of the pulling means or the medium-voltage line lifting off from the supporting structure, and the smaller the amount of effort required when the medium-voltage line is being pulled up into the nacelle through the tower.

If, after the medium-voltage line has been successfully pulled up, the rollers are then moved back into the second position, the rollers do not extend as far into the receiving region as before, preferably no longer extend into the receiving region at all, and the medium-voltage line can be placed, partially or preferably completely, on the supporting structure, as a result of which the supporting structure can provide a holding action.

This significantly shortens the installation time required.

Additionally, the number of rollers may already have been installed on the supporting structure at the factory. However, it is also possible for the rollers to be provided separately as “miniature operating means” and to be installed on the supporting structure for the first time at the installation site. In some embodiments, operating means such as the cable corner rollers known from the prior art are completely unnecessary.

In one preferred embodiment, the receiving region of the supporting structure has a curved portion that spans an angular range of 60° or more, preferably 75° or more, or particularly preferably spans an angular range of 90° or more.

In another preferred embodiment, the supporting structure has a bearing surface for the line.

The further the number of rollers extend into the receiving region, the less the medium-voltage line or, before that, the pulling means comes into contact with the bearing surface, and the lower the frictional force the pulling device is required to overcome. Preferably, the number of rollers comprises a plurality of rollers that are distributed along the curved portion, preferably with an even spacing between respectively adjacent rollers. Preferably, respectively adjacent rollers are spaced apart from one another by an angle of curvature in a range from 10° to 30°, further preferably by an angle in a range from 12° to 18°. This achieves a deflection that requires only a small amount of force and also adequately protects the line from bending stress.

Further preferably, in the first position, the number of rollers extend into the receiving region to such an extent that the line is spaced apart from the bearing surface.

Further preferably, in the second position, the number of rollers are withdrawn from the receiving region to such an extent that the number of rollers are spaced apart from the line. In turn, this means that, in the second position of the rollers, the medium-voltage line or the pulling means can completely rest against the bearing surface, which ensures a holding action as a result of static friction. At the same time, the rollers are no longer mechanically loaded or may even be removed, see further below.

In another preferred embodiment, the number of rollers are operatively coupled to a slot guide that defines the first and the second positions as well as an adjustment path between the two positions. The slot guide is preferably formed in each case in the curved portion of the supporting structure and is configured to guide the number of rollers in a radial direction back and forth between the first position and the second position. In this context, if there are a plurality of rollers, each roller preferably has its own slot guide.

Preferably, the slot guide additionally has a tilt-prevention means in the form of a plurality of guide pins that are arranged laterally next to the slot and are configured to stop the rollers from tilting.

In another preferred embodiment, the bearing surface is formed from a plurality of spaced-apart surface segments. The bearing surface may be interrupted, for example, by a plurality of recesses in which the number of movable rollers are located, wherein a respective roller is preferably arranged in each recess. One, a plurality or all of the surface segments preferably have a friction material that increases friction. The friction material preferably takes the form of a rubber covering and is fastened, for instance adhesively bonded, to the surface segment.

In another preferred embodiment, the pulling device has a winch, preferably a continuous cable winch or alternatively a drum winch, and the pulling means has a winch cable, for example in the form of a steel cable. In preferred embodiments, the pulling device may either already be installed in the nacelle at the factory or, analogously to the number of rollers, first be mounted in the nacelle at the construction site of the wind power installation. In preferred embodiments, after the installation of the medium-voltage line in the nacelle has been completed, the pulling device may, for example, then be removed from the nacelle and reused for subsequent construction at another construction site. If a continuous cable winch is used, the winch cable is preferably led or guided outwards through a hatch in the central region of the nacelle during a lifting and lowering operation. This ensures that the winch cable runs smoothly, i.e. without interference, and is neither damaged nor causes any damage.

In another preferred embodiment, the number of rollers are mounted in a reversibly releasable manner on the supporting structure. This makes it possible to reuse the number of rollers, which are generally not significantly worn after a single installation of a medium-voltage line in the nacelle of the wind power installation and can therefore be used to support a large number of installation operations. Preferably, the number of rollers are arranged on the supporting structure in such a manner that the rollers may be removed from the installation when they are in the retracted, second position.

In another preferred embodiment, the supporting structure has a receptacle for a cable holder. In this respect, the supporting structure preferably has a tower-side, first end and an interface-side, second end, wherein the receptacle for the cable holder is arranged at the second end.

A spacing of 15 to 18 m in the vertical direction between the second end of the supporting structure and the nearest cable holding element in the tower would correspond to a weight of 150 to 180 kg for the part of the medium-voltage line in question, assuming a cable weight of 10 kg/m. However, some of this weight would not have to be absorbed by the cable holder; rather, if the cable holder is accordingly arranged at the second end, the weight would already have been absorbed by the supporting structure, in particular by its bearing surface, when the rollers are in the retracted, second position. This makes it possible to use a cable holder that is mechanically simple and has small dimensions. Torsion occurring in the cable during an azimuthal movement of the nacelle may also be absorbed by the supporting structure.

Use is preferably made, for instance, of a cable holder as shown in WO 2020/224909 A1. The content of this publication, in particular the description of the technical exemplary embodiment from page 14, line 18, to page 17, line 34, is incorporated herein by way of reference.

Further preferably, use is made of a plurality of cable holders, which are distributed along the supporting structure and are fastened to the supporting structure. The cable holders are preferably spaced apart from the rollers. This improves the introduction and distribution of the weight of the cable in the supporting structure. Particularly preferably, a plurality of cable holders are arranged in the region of the second—that is to say upper—end. A substantially horizontal orientation of the cable holders has an advantageous effect on the load-bearing capacity of the cable holders.

Some embodiments relate to the nacelle itself.

Furthermore, some embodiments relate to a method for routing a live line into a nacelle of a wind power installation, wherein the nacelle is designed according to one of the preferred embodiments described above and installed on a tower of the wind power installation.

As far as this method is concerned, some embodiments have the following steps:
moving the number of rollers into the advanced, first position,
lowering the pulling means, wherein the pulling means is guided in the receiving region and runs over the number of rollers,
connecting the pulling means to the live line in a region outside of the nacelle, in particular beneath the nacelle, preferably within the tower,
pulling the live line into the nacelle by way of the pulling means, wherein the line is bent from the first direction of extent into the second direction of extent within the predetermined bending radius,
moving the number of rollers into the retracted, second position, wherein the line is kept in the bent state, and
connecting the live line to the electrical interface.

With regard to the method, some embodiments make use of the same advantages and considerations as the nacelle described herein. Preferred embodiments of the nacelle described herein are likewise preferred embodiments of the method and vice versa; therefore, in order to avoid repetition, reference is made to the above embodiments.

The method is advantageously developed by additionally comprising the steps of:
attaching the number of rollers to the supporting structure before the pulling means has been lowered, in particular before the number of rollers have been moved into the first position, and/or
removing the number of rollers from the supporting structure after the line has been pulled into the nacelle, in particular after the number of rollers have been moved into the second position.

### BRIEF DESCRIPTION OF THE SEVERAL VIEWS OF THE DRAWINGS

Embodiments of the invention will be described in more detail hereinbelow on the basis of a preferred exemplary embodiment with reference to the appended figures, in which:

FIG. 1 shows a schematic three-dimensional view of a wind power installation according to the preferred exemplary embodiment,

FIG. 2 shows a schematic cross-sectional view through a nacelle of the wind power installation according to FIG. 1,

FIG. 3 shows a detail-specific view of a supporting structure of the nacelle according to FIGS. 1 and 2,

FIG. 4 shows another detail-specific view of the supporting structure according to FIG. 3,

FIG. 5 shows another detail-specific view of the supporting structure according to FIGS. 3 and 4, and

FIG. 6 shows an interior view of the nacelle according to FIGS. 1 to 5.

### DETAILED DESCRIPTION

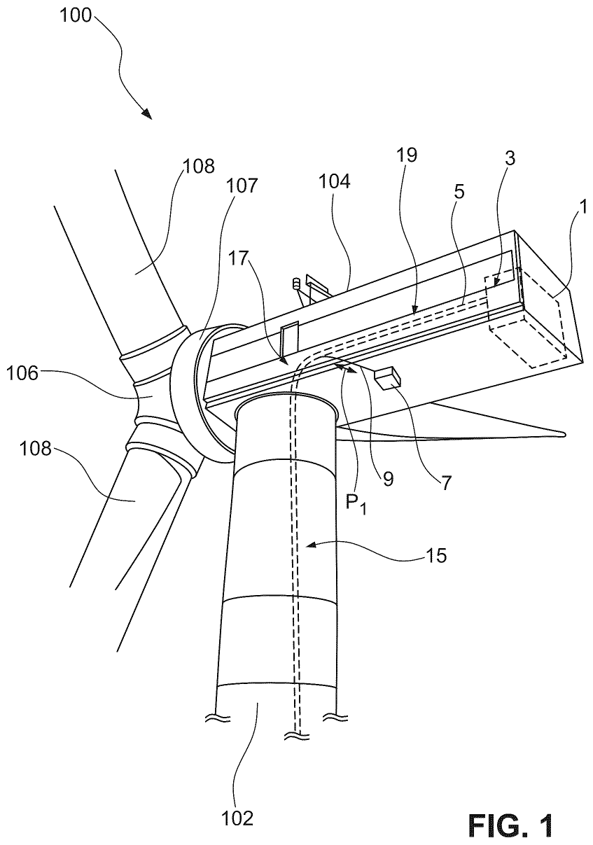

FIG. 1 shows a wind power installation 100. The wind power installation 100 has a tower 102, on top of which a nacelle 104 is arranged. A hub 106, which is mounted in a rotatable manner and has a number of rotor blades 108, which drive a generator 107 in order to generate electrical power, is arranged on the nacelle 104.

An installation transformer 1 is arranged in the nacelle 104. The installation transformer 1 is located on a side of the nacelle 104 that, in relation to the axis of the tower, faces away from the hub 106.

The installation transformer 1 has an electrical interface 3, which is configured to connect to a medium-voltage line 5 (hereinafter: line 5). The line 5 is indicated by dashed lines.

A pulling device 7 is also installed in the nacelle 104 and has a pulling means 9, which can be pulled in and out in the direction of the arrow P₁ so as to be lowered down and pulled up through the tower 102 in order to be able to install the line 5 in the nacelle 104.

The line 5 has a first line portion 15, which is oriented substantially parallel to the tower 102, that is to say substantially vertically, and a deflecting portion 17, in which the line 5 must be bent. Finally, the line 5 has, at its transformer-side end, a third portion 19, which is oriented substantially horizontally and may extend for example along the ceiling of the nacelle 104.

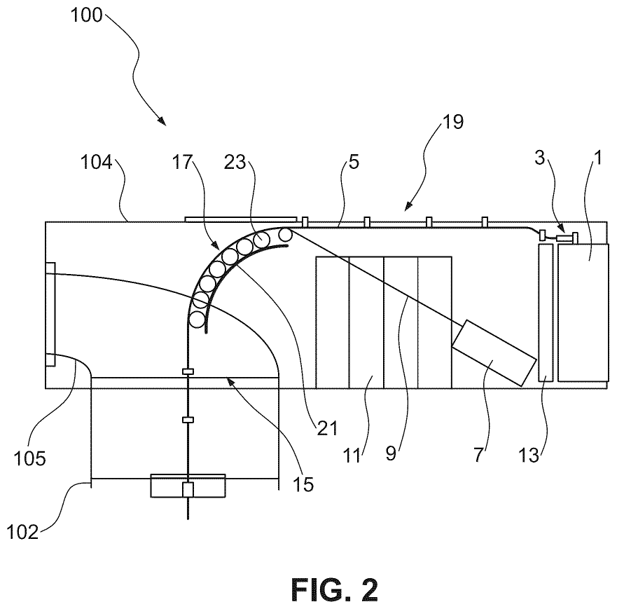

The schematic design of the interior structure of the nacelle 104 is shown in more detail in FIG. 2. A machinery carrier 105 extends from the tower 102 of the wind power installation 100, with the hub 106 and the generator 107 also being fastened to said machinery carrier. The line 5 extends, in a direction facing away from the hub side, as far as the installation transformer 1, to which said line is connected by way of the electrical interface 3. The deflecting portion 17 contains a supporting structure 21, which is permanently installed in the nacelle 104 and has a number of rollers 23, specifically a multiplicity of rollers 23, and more detail will be given in respect of the function thereof in the following figures. A number of control cabinets 11 and a low-voltage distributor structure 13 are also arranged in the nacelle 104.

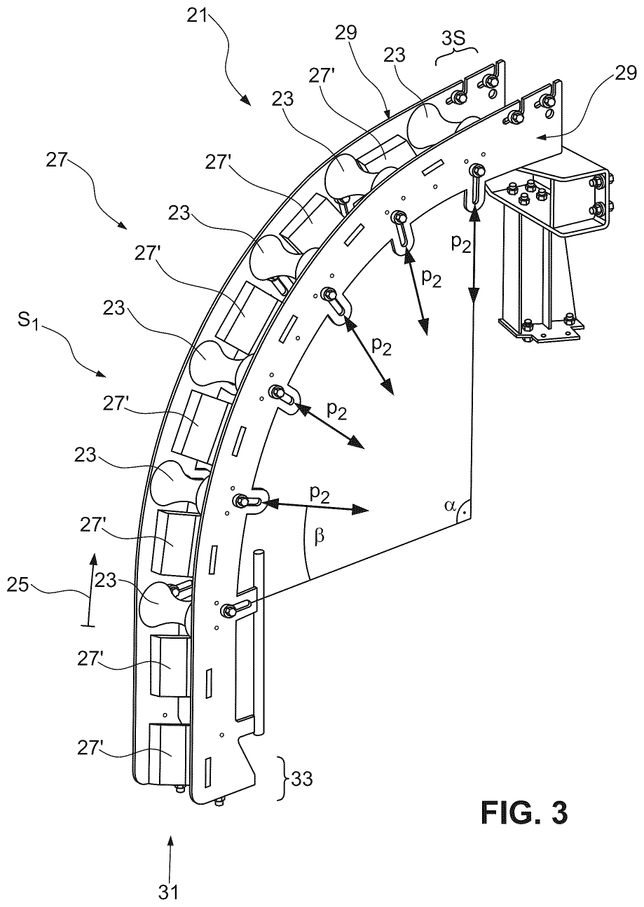

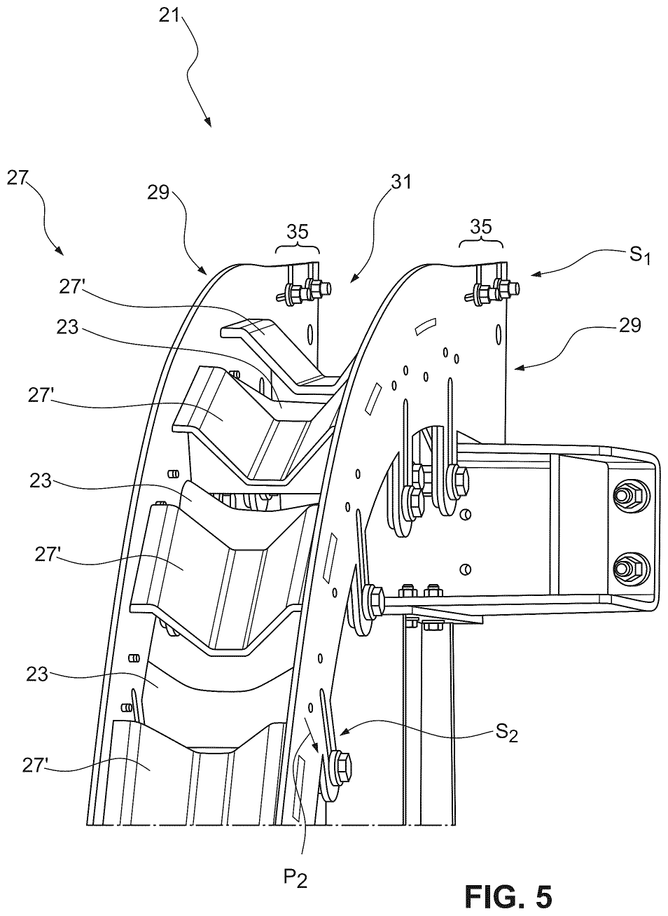

The curved supporting structure 21 is shown in more detail in FIG. 3. The rollers 23 of the supporting structure 21 are arranged in a curved portion 25, which extends over an angular range of α=90°. There are six rollers 23 in total. The rollers 23 are each spaced apart by an angle β, which is preferably in a range between 12° and 18°. Each of the rollers 23 is able to move radially in the direction of the arrows P₂ between an advanced, first position S₁, shown in FIG. 3, and a retracted position S₂, shown in FIG. 5.

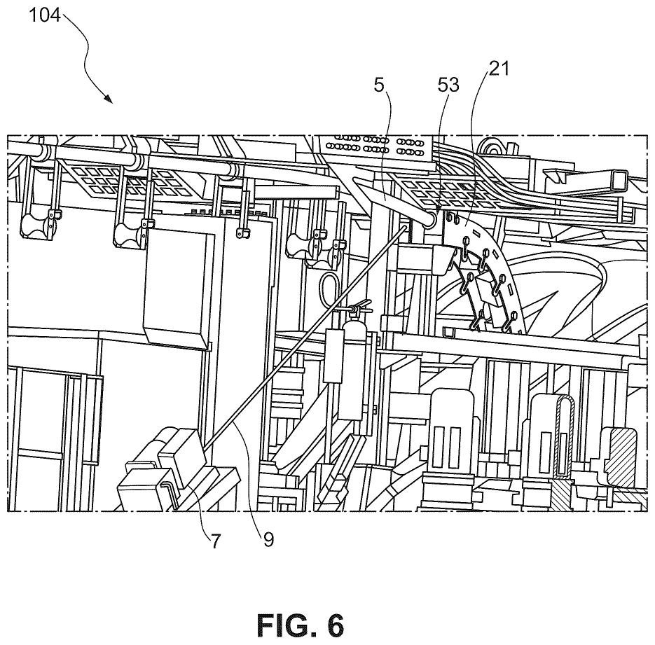

The supporting structure 21 has a tower-side, first end 33 and, arranged opposite thereto, an interface-side, second end 35, wherein the second end 35 is configured to receive a cable holder, which is shown in more detail in FIG. 6.

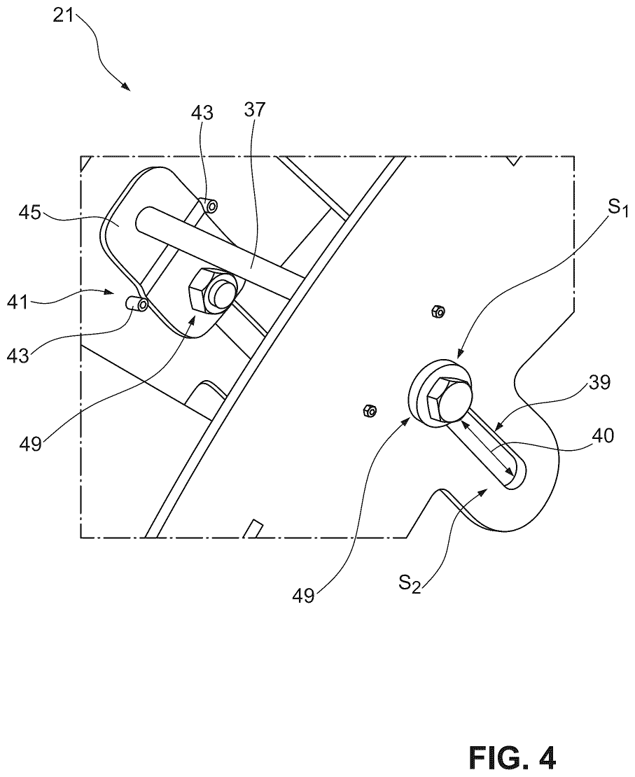

FIG. 4 shows the mechanism of one of the rollers 23, themselves omitted in FIG. 4, in the supporting structure 21. Each of the rollers 23 is mounted so as to rotate about a spindle 37 and is able to move in a slot guide 39 between the first position S₁, which is shown, and a second position S₂ (cf. FIG. 5). In this case, the slot guide 39 defines an adjustment path 40 between the first position S₁ and the second position S₂. In the exemplary embodiment shown, the adjustment path of the slot guide 39 runs in a radial direction, in the direction of the arrows P.

The slot guide 39 is additionally provided with a tilt-prevention means 41, which is intended to prevent the spindle 37 from tilting laterally. The tilt-prevention means 41 has two lateral pins 43, which act on opposite sides of a displaceable plate 45, which supports the axle 37 on both sides of the supporting structure 21. The rollers 23 may be locked in the first position S₁ or the second position S₂ for example by means of screw connections 49 attached to the ends of the mechanism.

By virtue of the screw connections 49 being removed, it is also possible for the rollers 23, preferably in the second position S₂, to be removed, together with the spindle 37, from the supporting structure 21 in order to be reused in a wind power installation after the line 5 has been successfully installed. Removing the rollers 23 requires a low level of outlay, and the transport outlay required to bring the rollers to the next wind power installation is also very favorable in comparison with the outlay required for the cable corner rollers known from the prior art.

As can clearly be seen in FIG. 5, in the second position S₂, the rollers 23 on the supporting structure 21 are withdrawn from the receiving region 31 to such an extent that a line 5, if one were routed within the receiving region 31, would no longer make contact with the rollers 23; rather, it would bear against the surface segments 27′ of the bearing surface 27. If a cable holder 53 is then installed in the interface-side end 35 in the receptacle 51 provided for this purpose, the bearing surface 27 additionally helps to hold the line 5 by means of static friction.

In the schematic three-dimensional illustration shown in FIG. 6, the winch 7 is shown once again in another orientation. The winch 7 is, as before, connected to the line 5 by way of its pulling means 9, which is for example a steel cable, in order for the attachment to be emphasized. However, the line 5 has already been installed in the nacelle 104 and guided in the direction of the installation transformer 1 in the vicinity of a ceiling of the nacelle 104. The entire installation operation may take place using the supporting structure 21, which is permanently installed in the wind power installation 100, wherein, for this purpose, the number of rollers 23 either merely need to be inserted into the supporting structure 21 or have already been inserted and merely need to be brought into the first position S₁.

During operation, the following method is preferably carried out:

First of all, the winch 7 with its pulling means 9 is provided in the nacelle 104, either at the factory or at the construction site. Then, the pulling means 9 is inserted into the receiving region 31 of the supporting structure 21 and is guided downwards through said receiving region in the tower 102 of the wind power installation 100. In the region of the base of the wind power installation 100, the line 5 is attached to the pulling means 9 and is then pulled upwards through the tower 102 and into the nacelle 104 by means of the winch 7. Whilst they are being pulled up into the nacelle 104, the pulling means 9 and subsequently the line 5 are guided into the receiving region 31 and, in the process, run over the rollers 23, which are in the first position S₁.

If the line 5 has been pulled into the nacelle 104 to a sufficient extent, the line 5 may be connected to the electrical interface 3 of the installation transformer 1.

After this, or even prior to this, the rollers 23 may be retracted from the first position S₁ into the second position S₂ in order to cause the line 5 to bear against the bearing surface 27 of the supporting structure 21 and to achieve a holding action. The holding action is preferably enhanced by a cable holder being inserted into the receptacle 51, this cable holder preventing the cable 5 from slipping axially, in particular in the direction of the tower 102, that is to say following gravity. After the line 5 has been successfully installed, the rollers 23 may either remain in the second position S₂ or preferably be removed from the supporting structure 21 and be prepared to be reused in another wind power installation. This makes it clear that embodiments of the invention can offer significant advantages in terms of the handling of the line 5. Although the number of actions needed to install and move the rollers 23 into their respective first position S₁ may initially appear to be a disadvantage, it has in fact transpired that using the supporting structure 21, which is needed in the wind power installation in any case, results in this handling being significantly more time-saving and cost-saving than using a separate operating means in the form of a cable corner roller, because the laborious and time-consuming process of transferring the line 5 from such an operating means to the supporting structure may be done away with altogether.

### LIST OF REFERENCE SIGNS

1 Installation transformer
3 Interface
5 Line
7 Winch
9 Pulling means
11 Control cabinet
13 Low-voltage distributor structure
15 Line portion
17 Deflecting portion
19 Third portion
21 Supporting structure
23 Rollers
25 Curved portion
27 Bearing surface
27′ Surface segment
31 Receiving region
33 First end
35 Second end
37 Spindle
39 Slot guide
40 Adjustment path
41 Tilt-prevention means
43 Pin
45 Plate
49 Screw connection
51 Receptacle
53 Cable holder
100 Wind power installation
102 Tower
104 Nacelle
105 Machinery carrier
106 Hub
107 Generator
108 Rotor blade
P₁, P₂ Arrow
S₁ First position
S₂ Second position
α Angle
β Angle

European patent application no. 22212585.8, filed Dec. 9, 2022, to which this application claims priority, is hereby incorporated herein by reference in its entirety. Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A nacelle of a wind power installation, the nacelle being configured to be installed on a tower of the wind power installation, wherein the nacelle:
has an installation transformer that is configured to transform electrical power generated by the wind power installation for feeding into a medium-voltage grid, and has an electrical interface for connecting at least one medium-voltage line, wherein the line runs through the tower of the wind power installation into the nacelle,
has a pulling device that is installed in the nacelle and comprises a pulling means configured to pull the line into the nacelle for connection to the electrical interface, and
has a supporting structure that is installed in the nacelle, has a receiving region for the pulling means or the line and is configured to keep the line within a predetermined bending radius in the receiving region,
wherein the supporting structure has a number of rollers that are mounted on the supporting structure so as to be able to move back and forth between an advanced, first position and a retracted, second position, wherein, in the first position, the number of rollers extend further into the receiving region than in the second position.

2. The nacelle according to claim 1, wherein the receiving region has a curved portion that spans an angular range of 60° or more, preferably 75° or more, particularly preferably 90° or more.

3. The nacelle according to claim 1, wherein the supporting structure has a bearing surface for the line.

4. The nacelle according to claim 1, wherein the number of rollers comprises a plurality of rollers that are distributed along the curved portion, preferably with an even spacing between respectively adjacent rollers.

5. The nacelle according to claim 3, wherein, in the first position, the number of rollers extend into the receiving region to such an extent that the line is spaced apart from the bearing surface.

6. The nacelle according to claim 1, wherein, in the second position, the number of rollers are withdrawn from the receiving region to such an extent that the number of rollers are spaced apart from the line.

7. The nacelle according to claim 1, wherein the number of rollers are operatively coupled to a slot guide that defines the first and second positions as well as an adjustment path between the two positions.

8. The nacelle according to claim 7, wherein the slot guide is configured to guide the number of rollers in a radial direction back and forth between the first position and the second position.

9. The nacelle according to claim 1, wherein the bearing surface is formed from a plurality of spaced-apart surface segments.

10. The nacelle according to claim 1, wherein the pulling device has a winch, preferably a drum winch, and in that the pulling means has a winch cable.

11. The nacelle according to claim 1, wherein the number of rollers are mounted in a reversibly releasable manner on the supporting structure.

12. The nacelle according to claim 1, wherein the supporting structure has a receptacle for a cable holder.

13. The nacelle according to claim 12, wherein the supporting structure has a tower-side, first end and an interface-side, second end, and in that the receptacle for the cable holder is arranged at the second end.

14. A method for routing a live line into a nacelle of a wind power installation, wherein the nacelle is designed according to claim 1 and installed on a tower of the wind power installation, the method comprising:
moving the number of rollers into the advanced, first position,
lowering the pulling means, wherein the pulling means is guided in the receiving region and runs over the number of rollers,
connecting the pulling means to the live line in a region outside of the nacelle, in particular beneath the nacelle, preferably within the tower,
pulling the live line into the nacelle by way of the pulling means, wherein the line is bent from the first direction of extent into the second direction of extent within the predetermined bending radius,
moving the number of rollers into the retracted, second position, wherein the line is kept in the bent state, and
connecting the live line to the electrical interface.

15. The method according to claim 14, further comprising:
attaching the number of rollers to the supporting structure before the pulling means has been lowered, in particular before the number of rollers have been moved into the first position, and/or
removing the number of rollers from the supporting structure after the line has been pulled into the nacelle, in particular after the number of rollers have been moved into the second position.
